(19) United States
(12) Patent Application Publication
(10) Pub. No.: US 2009/0192248 A1
(43) Pub. Date: Jul. 30, 2009

(54) Method of preparing a pigment composition

(76) Inventors: Paul S. Palumbo, West Newton, MA (US); Dave S. Pope, Andover, MA (US); John Mathew, Hampton, NH (US)

Correspondence Address: LAW DEPARTMENT;CABOT CORPORATION, 157 CONCORD ROAD, BILLERICA, MA, 01821, US

(21) Appl. No.: 12/315,694

(22) Filed: Dec. 5, 2008

Related U.S. Application Data
(60) Provisional application No. 61/005,708, filed on Dec. 7, 2007.

(51) Int. Cl. C08K 5/17; C08G 63/00

(52) U.S. Cl. 524/186; 524/599; 524/539

(57) ABSTRACT

The present invention relates to a method of preparing a pigment composition comprising the steps of combining at least one polyamine, at least one pigment, and at least one polymer having at least one carboxylic acid group or salt thereof. Various embodiments of this method are disclosed. The present invention further relates to a pigment composition and uses thereof, such as inkjet ink compositions.

### CROSS-REFERENCE TO RELATED APPLICATIONS

This patent application claims the benefit of U.S. Provisional Patent Application No. 61/005,708, filed Dec. 7, 2007.

### BACKGROUND OF THE INVENTION

1. Field of the Invention

The present invention relates to a method of preparing a pigment composition comprising a pigment and a polymer as well as the resulting pigment composition and inkjet ink compositions comprising the pigment composition.

2. Description of the Related Art

An inkjet ink composition generally consists of a vehicle, which functions as a carrier, and a colorant such as a dye or pigment. Additives and/or cosolvents can also be incorporated in order to adjust the inkjet ink to attain the desired overall performance properties.

In general, pigments alone are not readily dispersible in liquid vehicles. A variety of techniques have been developed which can provide stable pigment dispersions that can be used in inkjet printing. For example, dispersants can be added to the pigment to improve its dispersibility in a particular medium. Examples of dispersants include water-soluble polymers and surfactants. Typically, these polymeric dispersants have a molecular weight less than 20,000 in order to maintain solubility and therefore pigment stability.

The surface of pigments contain a variety of different functional groups, and the types of groups present depend on the specific class of pigment. Several methods have been developed for grafting materials and, in particular, polymers to the surface of these pigments. For example, it has been shown that polymers can be attached to carbon blacks containing surface groups such as phenols and carboxyl groups. However, methods which rely on the inherent functionality of a pigment's surface cannot be applied generally because not all pigments have the same specific functional groups.

Methods for the preparation of modified pigment products have also been developed which can provide a pigment with a variety of different attached functional groups. For example, U.S. Pat. No. 5,851,280 discloses methods for the attachment of organic groups onto pigments including, for example, attachment via a diazonium reaction wherein the organic group is part of the diazonium salt.

Other methods to prepare modified pigments, including those having attached polymeric groups, have also been described. For example, PCT Publication No. WO 01/51566 discloses methods of making a modified pigment by reacting a first chemical group and a second chemical group to form a pigment having attached a third chemical group. Ink compositions, including inkjet inks, containing these pigments are also described. Also, U.S. Pat. No. 5,698,016 discloses a composition comprising an amphiphilic ion and a modified carbon product comprising carbon having attached at least one organic group. The organic group has a charge opposite to the amphiphilic ion. Also disclosed are aqueous and non-aqueous ink and coating compositions incorporating this composition, including ink jet ink compositions. In addition, polymer coated carbon products and methods for their preparation are described in U.S. Pat. No. 6,458,458 and multi-layer pigments and method for their preparation are disclosed in U.S. Patent Publication No. 2006/0178447.

While these methods provide modified pigments having attached groups, there remains a need for improved processes for preparing pigment compositions, particularly those that comprise polymers, thereby providing advantageous alternatives to forming modified pigments.

### SUMMARY OF THE INVENTION

The present invention relates to a method of preparing a pigment composition comprising the steps of combining a polyamine, a pigment, and a polymer having at least one carboxylic acid group or salt thereof. In one embodiment, the method comprising the steps of combining the polyamine and the pigment to form a coated pigment and combining the coated pigment with the polymer, which is either in the form of a polymer melt or is subsequently heated to a temperature sufficient to form a polymer melt. In a second embodiment, the method comprises the steps of combining the polyamine and the pigment, in any order, with the polymer, which is in the form of a polymer melt. The present invention further relates to the pigment composition prepared by this method, as well as to inkjet ink compositions comprising the pigment composition.

It is to be understood that both the foregoing general description and the following detailed description are exemplary and explanatory only and are intended to provide further explanation of the present invention, as claimed.

### DETAILED DESCRIPTION OF THE INVENTION

The present invention relates to methods of preparing pigment compositions, to pigment compositions, and to inkjet ink compositions comprising the pigment compositions.

The method of the present invention comprises the step of combining a polyamine, a pigment, and a polymer having at least one carboxylic acid group or salt thereof, which is either in the form of a melt or is subsequently heated to form a melt. Each of these will be discussed separately below. The components may be combined in any order. For example, in one embodiment of the present invention, the method comprises the step of combining the polyamine and the pigment to form a coated pigment. The resulting coated pigment is then combined with the polymer, which is in the form of a melt, or, alternatively, is combined with the polymer, and the resulting mixture heated to a temperature sufficient to form a melt of the polymer, such as a temperature greater than the Tg of the polymer. Also, in a second embodiment of the method of the present invention, the polyamine and pigment are added to a melt of the polymer formed by heating the polymer, such as to a temperature above the polymer Tg or, alternatively, added to the polymer and the resulting mixture is then heated to a temperature sufficient to form a melt of the polymer. Other combinations are also possible.

For the method of the present invention, the polyamine can be any material having more than one amine group, preferably two or more primary amine groups and/or secondary amine groups. The polyamine may be an aromatic or heteroaromatic polyamine (such as phenylenediamine, aminobenzylamine, or aminophenethylamine) or a branched or unbranched, cyclic or acyclic alkyl polyamine (such an alkylene diamine). Specific examples of suitable alkyl polyamines include ethylenediamine, diethylenetriamine, triethylenetetraamine, tetraethylenepentamine, pentaethylenehexamine, hexamethylenediamine, and isomers thereof. The polyamine may also be a polymeric compound having two or more amine groups either as end groups, as part of the polymeric backbone, or as groups pendant to the polymeric backbone. Suitable examples include, for example, polyvinylamines, polyallylamines, linear or branched polyalkylene imines (such as polyethyleneimine and polypropyleneimine), polyamides containing amino end groups, polyacrylates containing amino pendant groups, and dendrimers such as polyamidoamines (PAMAM). Materials having more than two amine groups are preferred since these polyamines would provide additional sites for reaction or interaction with the pigment and/or the polymer, as discussed in more detail below.

The polyamine can be in the form of either a solid or a liquid. When in the form of a liquid, the polyamine can be in the form of a solution in a first solvent, which may be an aqueous solvent (comprising greater than or equal to 50% by weight water) or a non-aqueous solvent (comprising less than 50% by weight water). Preferably the solvent is one having a boiling point that is below the melting temperature of the polymer, described in more detail below. Specific examples of solvents include water, alcohol (such as methanol or ethanol), ethers (such as diethyl ether or THF), or ketone solvents (such as acetone or methyl ethyl ketone). Water and alcohol solvents are preferred.

The pigment used in the method of the present invention can be any type of pigment conventionally used by those skilled in the art, including carbonaceous black pigments and organic colored pigments. Mixtures of different pigments can also be used. Representative examples of carbonaceous black pigments include various carbon blacks (Pigment Black 7) such as channel blacks, furnace blacks, gas blacks, and lamp blacks, and include, for example, carbon blacks sold under the Regal®, Black Pearls®, Elftex®, Monarch®, Mogul®, and Vulcan® trademarks available from Cabot Corporation (such as Black Pearls® 2000, Black Pearls® 1400, Black Pearls® 1300, Black Pearls® 1100, Black Pearls® 1000, Black Pearls® 900, Black Pearls® 880, Black Pearls® 800, Black Pearls® 700, Black Pearls® 570, Black Pearls® L, Elftex® 8, Monarch® 1400, Monarch® 1300, Monarch® 1100, Monarch® 1000, Monarch® 900, Monarch® 880, Monarch® 800, Monarch® 700, Regal® 660, Mogul® L, Regal® 330, Regal® 400, Vulcan® P). Carbon blacks available from other suppliers can be used. Representative examples of organic colored pigments include, for example, blue, black, brown, cyan, green, white, violet, magenta, red, orange, or yellow organic pigments. Suitable classes include, for example, anthraquinones, phthalocyanine blues, phthalocyanine greens, diazos, monoazos, pyranthrones, perylenes, heterocyclic yellows, quinacridones, quinolonoquinolones, and (thio)indigoids. Such pigments are commercially available in either powder or press cake form from a number of sources including, BASF Corporation, Engelhard Corporation, Sun Chemical Corporation, Clariant, and Dianippon Ink and Chemicals (DIC). Examples of other suitable colored pigments are described in the Colour Index, 3rd edition (The Society of Dyers and Colourists, 1982). Preferably the pigment is a cyan pigment, such as Pigment Blue 15 or Pigment Blue 60, a magenta pigment, such as Pigment Red 122, Pigment Red 177, Pigment Red 185, Pigment Red 202, or Pigment Violet 19, a yellow pigment, such as Pigment Yellow 74, Pigment Yellow 128, Pigment Yellow 139, Pigment Yellow 155, Pigment Yellow 180, Pigment Yellow 185, Pigment Yellow 218, Pigment Yellow 220, or Pigment Yellow 221, an orange pigment, such as Pigment Orange 168, a green pigment, such as Pigment Green 7 or Pigment Green 36, or black pigment, such as carbon black.

The pigment may also be a pigment, particularly a carbonaceous black pigment, that has been oxidized using an oxidizing agent in order to introduce ionic and/or ionizable groups onto the surface. Pigments prepared in this way have been found to have a higher degree of oxygen-containing groups on the surface. Oxidizing agents include, but are not limited to, oxygen gas, ozone, NO₂ (including mixtures of NO₂ and air), peroxides such as hydrogen peroxide, persulfates, including sodium, potassium, or ammonium persulfate, hypohalites such a sodium hypochlorite, halites, halates, or perhalates (such as sodium chlorite, sodium chlorate, or sodium perchlorate), oxidizing acids such a nitric acid, and transition metal containing oxidants, such as permanganate salts, osmium tetroxide, chromium oxides, or ceric ammonium nitrate. Mixtures of oxidants may also be used, particularly mixtures of gaseous oxidants such as oxygen and ozone. In addition, pigments, particularly carbonaceous black pigments, prepared using other surface modification methods to introduce ionic or ionizable groups onto a pigment surface, such as chlorination and sulfonylation, may also be used.

The pigment may also be a modified pigment comprising a pigment having attached at least one organic group. Preferably the organic group is directly attached. For example, the modified pigment may be a pigment having attached at least one organic group which comprises at least one ionic group, at least one ionizable group, or a mixture thereof. An ionic group is either anionic or cationic and is associated with a counterion of the opposite charge including inorganic or organic counterions such as Na⁺, K⁺, Li⁺, NH₄⁺, NR′₄⁺ acetate, NO₃⁻, SO₄⁻², OH⁻, and Cl⁻, where R′ represents hydrogen or an organic group such as a substituted or unsubstituted aryl and/or alkyl group. An ionizable group is one that is capable of forming an ionic group in water and is, to some extent, associated with its counterion in a medium of low polarity, unless additives are used to disassociate the counterion. Anionizable groups form anions and cationizable groups form cations. Thus, the organic group is an organic ionic or ionizable group. Such groups include those described in U.S. Pat. No. 5,698,016, the description of which is fully incorporated herein by reference.

As an example, the modified pigment comprises a pigment having attached at least one organic group comprising at least one anionic group and/or at least one anionizable group. Anionic groups are negatively charged ionic groups that may be generated from groups having ionizable substituents that can form anions (anionizable groups), such as acidic substituents. They may also be the anion in the salts of ionizable substituents. Representative examples of anionic groups include —COO⁻, —SO₃⁻, —OSO₃⁻, —HPO₃⁻, OPO₃⁻², and —PO₃⁻². Representative examples of anionizable groups include —COOH, —SO₃H, —PO₃H₂, —R′SH, —R′OH, and —SO₂NHCOR′, where R′, which can be the same or different, represents hydrogen or an organic group such as a substituted or unsubstituted aryl and/or alkyl group. For example, the organic group comprises a carboxylic acid group, a sulfonic acid group, a sulfate group, or salts thereof and may be, for example, a group such as a benzene carboxylic acid group, a benzene dicarboxylic acid group, a benzene tricarboxylic acid group, a benzene sulfonic acid group, or salts thereof. Specific organic groups include —C₆H₄—CO₂H, —C₆H₄SO₃H, or salts thereof. The attached organic group may also be a substituted derivative of any of these.

As another example, the modified pigment may comprise a pigment having attached at least one cationic group, which is a positively charged organic ionic group that may be generated from ionizable substituents that can form cations (cationizable groups), such as protonated amines. For example, alkyl or aryl amines may be protonated in acidic media to form ammonium groups —NR′₂H⁺, where R′ represent an organic group such as a substituted or unsubstituted aryl and/or alkyl group. Cationic groups may also be positively charged organic ionic groups. Examples include quaternary ammonium groups (—NR′₃⁺) and quaternary phosphonium groups (—PR′₃⁺). Here, R′ represents hydrogen or an organic group such as a substituted or unsubstituted aryl and/or alkyl group. Specific examples include organic groups comprising an alkyl amine group (such as a benzylamine group) or a salt thereof or an alkyl ammonium group.

The modified pigments may be prepared using any method known to those skilled in the art such that organic chemical groups are attached to the pigment. For example, the modified pigments can be prepared using the methods described in U.S. Pat. Nos. 5,554,739, 5,707,432, 5,837,045, 5,851,280, 5,885,335, 5,895,522, 5,900,029, 5,922,118, and 6,042,643, and PCT Publication WO 99/23174, the descriptions of which are fully incorporated herein by reference. Such methods provide for a more stable attachment of the groups onto the pigment compared to dispersant type methods, which use, for example, polymers and/or surfactants. Other methods for preparing the modified pigments include reacting a pigment having available functional groups with a reagent comprising the organic group, such as is described in, for example, U.S. Pat. No. 6,723,783, which is incorporated in its entirety by reference herein. Such functional pigments may be prepared using the methods described in the references incorporated above. In addition modified carbon blacks containing attached functional groups may also be prepared by the methods described in U.S. Pat. Nos. 6,831,194 and 6,660,075, U.S. Patent Publication Nos. 2003-0101901 and 2001-0036994, Canadian Patent No. 2,351,162, European Patent No. 1 394 221, and PCT Publication No. WO 04/63289, as well as in N. Tsubokawa, Polym. Sci., 17, 417, 1992, each of which is also incorporated in their entirety by reference herein.

The pigment can have a wide range of BET surface areas, as measured by nitrogen adsorption, depending on the desired properties of the pigment. As known to those skilled in the art, a higher surface area will correspond to smaller particle size. If a higher surface area is not readily available for the desired application, it is also well recognized by those skilled in the art that the pigment may be subjected to conventional size reduction or comminution techniques, such as ball or jet milling, to reduce the pigment to a smaller particle size, if desired.

The pigment may be in the form of solid, such as a powder or a presscake, or in the form of a liquid, such as a dispersion of a solid pigment in a second solvent, which may be an aqueous solvent (comprising greater than or equal to 50% by weight water) or a non-aqueous solvent (comprising less than 50% by weight water). The second solvent can be any of the solvents described above relating to the polyamine, and may be either the same or different from the first solvent. Preferably the second solvent is one having a boiling point that is below the melting temperature of the polymer, described in more detail below. Specific examples of solvents include water, alcohol (such as methanol or ethanol), ethers (such as diethyl ether or THF), or ketone solvents (such as acetone or methyl ethyl ketone). Preferably, the second solvent is water.

When the polyamine, the pigment, or both are in the form of a solution in a solvent, the method of the present invention further comprises the step of removing the solvent prior to forming the pigment composition. For example, for the embodiment of the present method in which the polyamine and pigment are combined to form a coated pigment, which is either added to a melt of the polymer or added to the polymer and the resulting mixture heated to form a melt, the method of the present invention may further comprise the step of removing the first solvent and/or the second solvent after forming the coated pigment. Use of a polyamine solution and/or a pigment dispersion may provide a more consistent coating of the polyamine on the pigment and enable a wider variety of polyamines and pigments to be used. Also, the method may comprise the step of removing either or both solvents after adding the coated pigment to the polymer, as in the first embodiment of the method described above, or after combining the polyamine and pigment with the polymer, as in the second embodiment of the method described above. For example, the solvents may be removed on contact with the polymer melt or on heating the mixture to form a melt of the polymer. Other methods of removing the first solvent known in the art may also be used.

The polymer used in the method of the present invention comprises at least one carboxylic acid group or salt thereof, including, for example, sodium, potassium, or ammonium salts. The polymer can be a homopolymer or copolymer comprising the carboxylic acid group or salt thereof, and can be a random polymer, an alternating polymer, a graft polymer, a block polymer, a star-like polymer, and/or a comb-like polymer. Also, the carboxylic acid group or salt thereof may be an end-group of the polymer or a pendant group along the polymer backbone. Suitable polymers include those prepared by the polymerization of monomers comprising a carboxylic acid group or salt thereof and polymers prepared by the polymerization of monomers comprising groups which can be converted to carboxylic acid groups or salts thereof. Specific examples of polymers useful in the method of the present invention include, but are not limited to, polyacids such as polyacrylic acid, polymethacrylic acid, copolymers of acrylic acid or methacrylic acid, including styrene-acrylic acid and styrene-methacrylic acid polymers, partially or fully hydrolyzed derivatives of maleic anhydride-containing polymers, polyesters with carboxylic acid end groups, and polyurethanes containing carboxylic acid groups, as well as salts of any of these. The polymer may also comprise multiple types of carboxylic acid groups and salts.

The molecular weight of the polymer may vary depending on a variety of factors. For example, polymer molecular weight affects the solubility of the polymer, the viscosity of the resulting solution, as well as the form of the polymer (solid, wax, viscous liquid, or free flowing liquid). This may also affect the mixing or heating conditions used in the method of the present invention, which are described in more detail below. Preferably, the polymer has a weight average molecular weight of less than or equal to about 50,000, such as between about 1,000 and about 25,000, including between about 2,000 and 15,000 and between about 5,000 and about 10,000. Also, the polydispersity of the polymer may vary but is preferably less than or equal to about 3.

The polymer comprises at least one carboxylic acid group or salt thereof, and the amount of carboxylic acid group or salt thereof can vary depending a variety of factors, including the desired properties of the resulting pigment composition. For example, the polymer can comprise at least 10% by weight of the carboxylic acid group or salt thereof, including at least 20% by weight and at least 30% by weight. Also as an example, the polymer can have an acid number of between about 20 and about 400, including between about 30 and about 250 and between about 50 and about 170. Preferably, the polymer has sufficient carboxylic acid groups or salts thereof that it is a water soluble polymer.

In addition, it is within the scope of the present invention to use mixtures of different types of carboxylic acid group containing polymers. For example, the polymer may comprise a first polymer having at least one carboxylic acid group or salt thereof and a second polymer having at least one carboxylic acid group or salt thereof, which is different from the first polymer in, for example, composition, solubility, molecular weight, and/or acid number. For example, the first polymer can be one having a lower acid number, such as between about 20 and about 100, including between about 20 and about 60, than the second polymer, which may have an acid number of between about 110 and about 400, including between about 150 and about 250. By combining a carboxylic acid group containing polymer with a high acid number, which typically has good water solubility, and a carboxylic acid group containing polymer with a lower acid number, with typically poorer water solubility, it has been found that that a pigment composition can be prepared which has good overall properties in an aqueous dispersion, and, in particular, an aqueous inkjet ink composition, described in more detail below.

Also within the scope of the present invention is the use of polymers having at least one group capable of reacting with an amino group, other than a carboxylic acid group or salt thereof) in combination with the polymer having at least one carboxylic acid group or salt thereof. For example, the polymer may comprise a first polymer having at least one carboxylic acid group or salt thereof and a second polymer having at least one group that can react with an amino group, including, for example, an anhydride group such as a styrene-maleic anhydride polymer. The ratio of the amount of first polymer to the second polymer can be varied depending on, for example, the properties of the polymers (including acid number, molecular weight, and viscosity of the polymer melt) and the desired performance properties of the resulting pigment composition (including, for example, print properties when used in an inkjet ink composition). Preferably, the ratio of the amount of the weight of the first polymer to the weight of the second polymer is between about 1:5 to about 1:50.

In the method of the present invention, the polyamine, the pigment, and the polymer are combined to form a pigment composition. The polymer is either in the form of a melt or is converted into a melt after being combined with the polyamine and/or the pigment. The melt can be formed using any method known in the art, including, for example, by heating the polymer above its glass transition temperature, Tg. Preferably, the polymer has a Tg of between about 50° C. and about 140° C., more preferably between about 60 and about 130° C., and more preferably between about 70° C. and about 120° C. Thus, the polymer melt may be formed by heating the polymer to a temperature greater than about 100° C., preferably greater than about 120° C. and more preferably greater than about 140° C. The polymer melt may also be formed by subjecting the polymer, or the mixture containing the polymer, to high shear or high intensity mixing conditions. Such conditions are known to one skilled in the art, or can be determined based on the properties of the polymer, and can be achieved using a variety of mixers and similar equipment that are designed to mix, blend, stir, homogenize, disperse, and/or compound materials. Any mixer used for processing high viscosity materials can be used in the process of the present invention, not just those described traditionally as high intensity mixers. These are described in Perry's Chemical Engineer's Handbook (7′ Edition), Chapter 18, pages 18-25 to 18-32, which is incorporated in its entirety herein by reference. The high intensity mixer can be batch, semi-continuous, or continuous mixer. A continuous mixer which offers both economic and practical advantages to batch processing equipment and is generally preferred. Examples of mixers include, but are not limited to, single or double planetary mixers, dual shaft planetary mixers (particularly those in which one shaft has a saw tooth blade), helical mixers such as double helical mixers or twin blade conical mixers, double arm kneading mixers such as a Brabender or Farrel mixer, high intensity mixers such a Henschel or papenmeir mixers, two or three roll mixers, and single or double (twin) screw extruders. The high intensity mixing conditions may also include low pressure conditions resulting from the use of a vacuum.

The polymer may be in a solid or liquid form prior to being converted into a polymer melt. For example, the polymer may be a solution, dispersion, or suspension in a third solvent which may be an aqueous solvent (comprising greater than or equal to 50% by weight water) or a non-aqueous solvent (comprising less than 50% by weight water). The third solvent can be any of the solvents described above relating to the polyamine and/or the pigment, and may be either the same or different from the first solvent, the second solvent, or both. Preferably the third solvent is one having a boiling point that is below the melting temperature of the polymer, such as water. For example, the polymer may be in the form of an aqueous solution (including a solution in which the polymer is partially or fully ionized through the use of a soluble hydroxide reagent, such as sodium or ammonium hydroxide) or suspension (such as a latex or emulsion).

When the polymer is in the form of a solution in a third solvent, the method of the present invention further comprises the step of removing the third solvent prior to forming the pigment composition. For example, as described above regarding the polyamine and the pigment, removal of the third solvent can occur prior to combining either the coated pigment or the polyamine and/or the pigment to the polymer, or it can occur after the components are combined, upon contact with or during formation of the polymer melt. Other methods of removing the first solvent known in the art may also be used. Use of a polymer in a third solvent, as a solution, dispersion, or suspension, may provide for the formation of a more consistent pigment composition, particularly when the polyamine and pigment are also in the form of a solution in a solvent. As a particular example, after combining the polyamine and pigment, or the coated pigment formed by combining the polyamine and pigment, and the polymer in the third solvent, the solvent may be removed with the use of a spray drying.

The method of the present invention is run for a time and at a temperature sufficient to produce a pigment composition. Both the reaction time and temperature will depend on several factors, including the type of polyamine, the type of pigment, the type of polymer, and the relative amounts of each. In general, the pigment composition is formed over a time between about 0.1 minutes and about 300 minutes, including between about 1 minute and about 120 minutes and between about 5 minutes and about 60 minutes, and at a temperature that is generally between about 25° C. and about 250° C. and is preferably between about 100° C. and about 200° C.

The amounts of polyamine, pigment, and polymer used can be varied depending on, for example, the properties of each of these components and the desired properties of the resulting pigment composition. For example, the polyamine and the pigment can be combined in a weight ratio of from about 0.001:1 to about 0.5:1 polyamine to pigment, including a weight ratio of from about 0.005:1 to about 0.3:1 polyamine to pigment. Also, the polymer and the coated pigment, formed by combining the polyamine and the pigment, can be combined in a weight ratio of between about 0.1:1 and about 10:1 polymer to coated pigment, including between about 0.5:1 and about 6:1 polymer to coated pigment.

The method of the present invention results in the formation of a pigment composition comprising a pigment and a polymer. Thus, the present invention further relates to a pigment composition comprising the combination product of a coated pigment and at least one polymer having at least one carboxylic acid group or salt thereof. The coated pigment comprises a combination product of a polyamine and a pigment and may either be a reaction product of the polyamine and pigment or may comprise the polyamine adsorbed onto the pigment. Preferably, the pigment composition is a reaction product of the coated pigment and the polymer. The polyamine, pigment, and polymer can be any of those described in more detail above. Preferably, the pigment composition of the present invention is prepared using the method of the present invention, described in detail above.

While not wishing to be bound by theory, it is believed that the pigment composition comprises the pigment encapsulated or coated by the polymer through the intervention of the polyamine. For example, it is believed that, for the embodiment in which the polyamine and the pigment are combined to form a coated pigment, the components react or interact with each other, and the resulting coated pigment comprises either the polyamine adsorbed onto the pigment or the reaction product of the polyamine and the pigment, in which the polyamine has, for example, reacted with groups of the pigment. The resulting coated pigment, which comprises amine groups, is then believed to interact or react with the polymer, which is facilitated by the formation of the polymer melt. Thus, it is believed that the resulting pigment composition, which is a combination product of the coated pigment and the polymer, is a reaction product of these components, in which the amine groups of the pigment react with the carboxylic acid groups of the polymer. For this reason, polyamines having more than two amine groups are preferred, as discussed in more detail above. For the embodiment in which the polyamine and pigment are combined with the polymer, either as a melt or is subsequently converted to a melt, it is believed that the same interactions/reactions also occur. However, while it is possible to combine the polyamine, pigment and polymer in this way, it is believed to be particularly advantageous to combine the polyamine and pigment to form a coated pigment and subsequently combine this with the polymer, either as a melt or heated to form a melt, in order to provide better control over the suspected reactions or interactions. Prior methods of forming pigment compositions, including modified pigments comprising a pigment having attached at least one polymeric group, have required additional components, such as diazotizing agents, in order to form the desired products. Surprisingly it has been found that polyamines can be used in combination with a polymer having at least one carboxylic acid group or salt thereof and, when in the form of a melt, such a method produces a pigment composition comprising the pigment and the polymer without any additional components or addition processing steps, which can add unnecessary cost and complexity to the process.

Thus, the present invention further relates to a pigment composition comprising a pigment having adsorbed or attached at least one reacted polymer, which is the reaction product of the polymer, described above, and the polyamine of the coated pigment. The amount attached or adsorbed reacted polymer will differ depending on, for example, the conditions used to prepare the pigment composition, the type of polymer, the type of polyamine, and the type of pigment. However, the reacted polymer is preferably present in an amount between about 20% and about 50% by weight, based on the total weight of the pigment composition. The reacted polymer differs from the polymer having at least one carboxylic acid group or salt thereof in composition, in the number of carboxylic acid groups, and/or in molecular weight. For example, the attached or adsorbed reacted polymer of the pigment composition has a weight average molecular weight that is at least about 10 times, including at least about 20 times, greater than that of the polymer. Thus, while not wishing to be bound by theory, it is believed that the polyamine facilitates crosslinking between chains of the attached or adsorbed polymer, building molecular weight.

The pigment composition of the present invention may be used in a variety of different applications, including, for example, plastic compositions, aqueous or non-aqueous inks, aqueous or non-aqueous coatings, rubber compositions, paper compositions and textile compositions. In particular, these pigment compositions have been found to be capable of forming stable aqueous dispersions that can be used in various aqueous compositions, including, for example, automotive and industrial coatings, paints, toners, adhesives, latexes, and inks. The pigment compositions have been found to be most useful in ink composition, especially inkjet inks.

Thus, the present invention further relates to an inkjet ink composition comprising a vehicle and the pigment composition described above. The vehicle can be either an aqueous or non-aqueous liquid vehicle, but is preferably a vehicle that contains water. Thus, the vehicle is preferably an aqueous vehicle, which is a vehicle that contains greater than 50% water and can be, for example, water or mixtures of water with water miscible solvents such as alcohols. Non-aqueous vehicles are those that contain less than 50% water or are not miscible with water. Preferably the aqueous vehicle is water, and the inkjet ink composition is an aqueous inkjet ink composition.

The inkjet ink compositions of the present invention, comprising a liquid vehicle and the pigment composition described above, can be prepared using any method known in the art. For example, the pigment composition may be combined with the liquid vehicle with agitation to produce a stable dispersion. Any equipment known in the art, such as a media or ball mill, or other high shear mixing equipment can be used, and various conventional milling media may also be used. Other methods for forming the dispersion will be known to one skilled in the art.

The amount of pigment composition used in the inkjet ink composition can be varied but is typically in an amount effective to provide the desired image quality (for example, optical density) without detrimentally affecting the performance of the inkjet ink. For example, typically, the pigment composition will be present in an amount ranging from about 0.1% to about 20% based on the weight of the inkjet ink composition.

The inkjet ink composition of the present invention can be formed with a minimum of additional components (additives and/or cosolvents) and processing steps. However, suitable additives may be incorporated in order to impart a number of desired properties while maintaining the stability of the compositions. For example, additional surface active agents, humectants, drying accelerators, penetrants, biocides, binders, and pH control agents, as well as other additives known in the art, may be added. The amount of a particular additive will vary depending on a variety of factors but generally ranges between 0% and 40%.

Surface active agents may be added to further enhance the colloidal stability of the composition or to change the interaction of the ink with either the printing substrate, such as printing paper, or with the ink printhead. Various anionic, cationic and nonionic surface active agents can be used in conjunction with the ink composition of the present invention, and these may be in solid form or as a water solution.

Representative examples of anionic surface active agents include, but are not limited to, higher fatty acid salts, higher alkyldicarboxylates, sulfuric acid ester salts of higher alcohols, higher alkyl-sulfonates, alkylbenzenesulfonates, alkylnaphthalene sulfonates, naphthalene sulfonates (Na, K, Li, Ca, etc.), formalin polycondensates, condensates between higher fatty acids and amino acids, dialkylsulfosuccinic acid ester salts, alkylsulfosuccinates, naphthenates, alkylether carboxylates, acylated peptides, α-olefin sulfonates, N-acrylmethyl taurine, alkylether sulfonates, secondary higher alcohol ethoxysulfates, polyoxyethylene alkylphenylether sulfates, monoglycylsulfates, alkylether phosphates, alkyl phosphates, and alkyl phosphonates. For example, polymers and copolymers of styrene sulfonate salts, unsubstituted and substituted naphthalene sulfonate salts (e.g. alkyl or alkoxy substituted naphthalene derivatives), aldehyde derivatives (such as unsubstituted alkyl aldehyde derivatives including formaldehyde, acetaldehyde, propylaldehyde, and the like), maleic acid salts, and mixtures thereof may be used as the anionic dispersing aids. Salts include, for example, Na⁺, Li⁺, K⁺, Cs⁺, Rb⁺, and substituted and unsubstituted ammonium cations. Specific examples include, but are not limited to, commercial products such as Versa® 4, Versa® 7, and Versa® 77 (National Starch and Chemical Co.); Lomar® D (Diamond Shamrock Chemicals Co.); Daxad®19 and Daxad® K (W. R. Grace Co.); and Tamol® SN (Rohm & Haas). Representative examples of cationic surfactants include aliphatic amines, quaternary ammonium salts, sulfonium salts, phosphonium salts and the like.

Representative examples of nonionic surface active agents that can be used in ink jet inks of the present invention include fluorine derivatives, silicone derivatives, acrylic acid copolymers, polyoxyethylene alkyl ether, polyoxyethylene alkylphenyl ether, polyoxyethylene secondary alcohol ether, polyoxyethylene styrol ether, ethoxylated acetylenic diols (such as Surfynol® 420, Surfynol® 440, and Surfynol® 465, available from Air Products), polyoxyethylene lanolin derivatives, ethylene oxide derivatives of alkylphenol formalin condensates, polyoxyethylene polyoxypropylene block polymers, fatty acid esters of polyoxyethylene polyoxypropylene alkylether polyoxyethylene compounds, ethylene glycol fatty acid esters of polyethylene oxide condensation type, fatty acid monoglycerides, fatty acid esters of polyglycerol, fatty acid esters of propylene glycol, cane sugar fatty acid esters, fatty acid alkanol amides, polyoxyethylene fatty acid amides and polyoxyethylene alkylamine oxides. For example, ethoxylated monoalkyl or dialkyl phenols may be used, such as Igepal® CA and CO series materials (Rhone-Poulenc Co.), Brij® Series materials (ICI Americas, Inc.), and Triton® series materials (Union Carbide Company). These nonionic surface active agents can be used alone or in combination with the aforementioned anionic and cationic dispersants.

The surface active agent may also be a natural polymer or a synthetic polymer dispersant. Specific examples of natural polymer dispersants include proteins such as glue, gelatin, casein and albumin; natural rubbers such as gum arabic and tragacanth gum; glucosides such as saponin; alginic acid, and alginic acid derivatives such as propyleneglycol alginate, triethanolamine alginate, and ammonium alginate; and cellulose derivatives such as methyl cellulose, carboxymethyl cellulose, hydroxyethyl cellulose and ethylhydroxy cellulose. Specific examples of polymeric dispersants, including synthetic polymeric dispersants, include polyvinyl alcohols, such as Elvanols from DuPont, Celvoline from Celanese, polyvinylpyrrolidones such as Luvatec from BASF, Kollidon and Plasdone from ISP, and PVP-K, Glide, acrylic or methacrylic resins (often written as “(meth)acrylic”) such as poly(meth)acrylic acid, Ethacryl line from Lyondell, Alcosperse from Alco, acrylic acid-(meth)acrylonitrile copolymers, potassium (meth)acrylate-(meth)acrylonitrile copolymers, vinyl acetate-(meth)acrylate ester copolymers and (meth)acrylic acid-(meth)acrylate ester copolymers; styrene-acrylic or methacrylic resins such as styrene-(meth)acrylic acid copolymers, such as the Joncryl line from BASF, Carbomers from Noveon, styrene-(meth)acrylic acid-(meth)acrylate ester copolymers, such as the Joncryl polymers from BASF, styrene-methylstyrene-(meth)acrylic acid copolymers, styrene-methylstyrene-(meth)acrylic acid-(meth)acrylate ester copolymers; styrene-maleic acid copolymers; styrene-maleic anhydride copolymers, such as the SMA™ resins from Sartomer that can be hydrolyzed in water, vinyl naphthalene-acrylic or methacrylic acid copolymers; vinyl naphthalene-maleic acid copolymers; and vinyl acetate copolymers such as vinyl acetate-ethylene copolymer, vinyl acetate-fatty acid vinyl ethylene copolymers, vinyl acetate-maleate ester copolymers, vinyl acetate-crotonic acid copolymer and vinyl acetate-acrylic acid copolymer; and salts thereof. Polymers, such as those listed above, variations and related materials, that can be used for dispersants and additives in inkjet inks are included in the Tego products from Degussa, the Ethacryl products from Lyondell, the Joncryl polymers from BASF, the EFKA dispersants from Ciba, and the Disperbyk and Byk dispersants from BYK Chemie.

Humectants and water soluble organic compounds may also be added to the inkjet ink composition of the present invention, particularly for the purpose of preventing clogging of the nozzle as well as for providing paper penetration (penetrants), improved drying (drying accelerators), and anti-cockling properties. Specific examples of humectants and other water soluble compounds that may be used include low molecular-weight glycols such as ethylene glycol, diethylene glycol, triethylene glycol, tetraethylene glycol and dipropylene glycol; diols containing from about 2 to about 40 carbon atoms, such as 1,3-pentanediol, 1,4-butanediol, 1,5-pentanediol, 1,4-pentanediol, 1,6-hexanediol, 1,5-hexanediol, 2,6-hexanediol, neopentylglycol (2,2-dimethyl-1,3-propanediol), 1,3-propanediol, 1,4-butanediol, 1,5-pentanediol, 1,6-hexanediol, 1,2,6-hexanetriol, poly(ethylene-co-propylene)glycol, and the like, as well as their reaction products with alkylene oxides, including ethylene oxides, including ethylene oxide and propylene oxide; triol derivatives containing from about 3 to about 40 carbon atoms, including glycerine, trimethylolpropane, 1,3,5-pentanetriol, 1,2,6-hexanetriol, and the like as well as their reaction products with alkylene oxides, including ethylene oxide, propylene oxide, and mixtures thereof; neopentylglycol, (2,2-dimethyl-1,3-propanediol), and the like, as well as their reaction products with alkylene oxides, including ethylene oxide and propylene oxide in any desirable molar ratio to form materials with a wide range of molecular weights; thiodiglycol; pentaerythritol and lower alcohols such as ethanol, propanol, iso-propyl alcohol, n-butyl alcohol, sec-butyl alcohol, and tert-butyl alcohol, 2-propyn-1-ol (propargyl alcohol), 2-buten-1-ol, 3-buten-2-ol, 3-butyn-2-ol, and cyclopropanol; amides such as dimethyl formaldehyde and dimethyl acetamide; ketones or ketoalcohols such as acetone and diacetone alcohol; ethers such as tetrahydrofuran and dioxane; cellosolves such as ethylene glycol monomethyl ether and ethylene glycol monoethyl ether, triethylene glycol monomethyl (or monoethyl)ether; carbitols such as diethylene glycol monomethyl ether, diethylene glycol monoethyl ether, and diethylene glycol monobutyl ether; lactams such as 2-pyrrolidone, N-methyl-2-pyrrolidone and ε-caprolactam; urea and urea derivatives; inner salts such as betaine, and the like; thio (sulfur) derivatives of the aforementioned materials including 1-butanethiol; t-butanethiol 1-methyl-1-propanethiol, 2-methyl-1-propanethiol; 2-methyl-2-propanethiol; thiocyclopropanol, thioethyleneglycol, thiodiethyleneglycol, trithio- or dithio-diethyleneglycol, and the like; hydroxyamide derivatives, including acetylethanolamine, acetylpropanolamine, propylcarboxyethanolamine, propylcarboxy propanolamine, and the like; reaction products of the aforementioned materials with alkylene oxides; and mixtures thereof. Additional examples include saccharides such as maltitol, sorbitol, gluconolactone and maltose; polyhydric alcohols such as trimethylol propane and trimethylol ethane; N-methyl-2-pyrrolidone; 1,3-dimethyl-2-imidazolidinone; sulfoxide derivatives containing from about 2 to about 40 carbon atoms, including dialkylsulfides (symmetric and asymmetric sulfoxides) such as dimethylsulfoxide, methylethylsulfoxide, alkylphenyl sulfoxides, and the like; and sulfone derivatives (symmetric and asymmetric sulfones) containing from about 2 to about 40 carbon atoms, such as dimethylsulfone, methylethylsulfone, sulfolane (tetramethylenesulfone, a cyclic sulfone), dialkyl sulfones, alkyl phenyl sulfones, dimethylsulfone, methylethylsulfone, diethylsulfone, ethylpropylsulfone, methylphenylsulfone, methylsulfolane, dimethylsulfolane, and the like. Such materials may be used alone or in combination.

Biocides and/or fungicides may also be added to the inkjet ink composition of the present invention. Biocides are important in preventing bacterial growth since bacteria are often larger than ink nozzles and can cause clogging as well as other printing problems. Examples of useful biocides include, but are not limited to, benzoate or sorbate salts, and isothiazolinones.

Various polymeric binders can also be used in conjunction with the inkjet ink composition of the present invention to adjust the viscosity of the composition as well as to provide other desirable properties. Suitable polymeric binders include, but are not limited to, water soluble polymers and copolymers such as gum arabic, polyacrylate salts, polymethacrylate salts, polyvinyl alcohols (Elvanols from DuPont, Celvoline from Celanese), hydroxypropylenecellulose, hydroxyethylcellulose, polyvinylpyrrolidinone (such as Luvatec from BASF, Kollidon and Plasdone from ISP, and PVP-K, Glide), polyvinylether, starch, polysaccharides, polyethyleneimines with or without being derivatized with ethylene oxide and propylene oxide including the Discole® series (DKS International); the Jeffamine® series (Huntsman); and the like. Additional examples of water-soluble polymer compounds include various dispersants or surfactants described above, including, for example, styrene-acrylic acid copolymers (such as the Joncryl line from BASF, Carbomers from Noveon), styrene-acrylic acid-alkyl acrylate terpolymers, styrene-methacrylic acid copolymers (such as the Joncryl line from BASF), styrene-maleic acid copolymers (such as the SMA™ resins from Sartomer), styrene-maleic acid-alkyl acrylate terpolymers, styrene-methacrylic acid-alkyl acrylate terpolymers, styrene-maleic acid half ester copolymers, vinyl naphthalene-acrylic acid copolymers, alginic acid, polyacrylic acids or their salts and their derivatives. In addition, the binder may be added or present in dispersion or latex form. For example, the polymeric binder may be a latex of acrylate or methacrylate copolymers (such as NeoCryl materials from NSM Neoresins, the AC and AS polymers from Alberdingk-Boley) or may be a water dispersible polyurethane (such as ABU from Alberdingk-Boley) or polyester (such as AQ polymers from Eastman Chemical). Polymers, such as those listed above, variations and related materials, that can be used for binders in inkjet inks are included in the Ethacryl products from Lyondell, the Joncryl polymers from BASF, the NeoCryl materials from NSM Neoresins, and the AC and AS polymers Alberdingk-Boley.

Various additives for controlling or regulating the pH of the inkjet ink composition of the present invention may also be used. Examples of suitable pH regulators include various amines such as diethanolamine and triethanolamine as well as various hydroxide reagents. An hydroxide reagent is any reagent that comprises an OH⁻ ion, such as a salt having an hydroxide counterion. Examples include sodium hydroxide, potassium hydroxide, lithium hydroxide, ammonium hydroxide, and tetramethyl ammonium hydroxide. Other hydroxide salts, as well as mixtures of hydroxide reagents, can also be used. Furthermore, other alkaline reagents may also be used which generate OH⁻ ions in an aqueous medium. Examples include carbonates such as sodium carbonate, bicarbonates such as sodium bicarbonate, and alkoxides such as sodium methoxide and sodium ethoxide. Buffers may also be added.

Additionally, the inkjet ink composition of the present invention may further incorporate conventional dyes to modify color balance and adjust optical density. Such dyes include food dyes, FD&C dyes, acid dyes, direct dyes, reactive dyes, derivatives of phthalocyanine sulfonic acids, including copper phthalocyanine derivatives, sodium salts, ammonium salts, potassium salts, lithium salts, and the like.

The inkjet ink compositions can be purified and/or classified to remove impurities and other undesirable free species which can co-exist as a result of the manufacturing process using any method known in the art including, for example, ultrafiltration/diafiltration using a membrane, reverse osmosis, and ion exchange. Also, the inkjet ink compositions can be subjected to a classification step, such as filtration, centrifugation, or a combination of the two methods to substantially remove particles having a size above, for example, about 1.0 micron. In this way, unwanted impurities or undesirable large particles can be removed to produce an inkjet ink composition with good overall properties.

The present invention will be further clarified by the following examples, which are intended to be only exemplary in nature.

### EXAMPLES

For each of the following examples, Black Pearls® carbon black (BP700) (available from Cabot Corporation), SS4 (available from Degussa), and colored pigments presscakes Pigment Yellow 74 (PY74), Pigment Blue 15:4 (PB15:4), and Pigment Red 122 (PR122) (available from Sun Chemical Company) was used, along with Joncryl 683 (J683, available from BASF), and pentaethylenehexamine (PEHA), hexamethylenediamine (HMDA), and absolute methanol (each available from Aldrich Chemical Company and used without further purification).

### Examples 1-17 and Comparative Examples 1-4

The following examples relate to an embodiment of the present invention in which a pigment composition is prepared by combining a polyamine and a pigment to form a coated pigment and combining the coated pigment and at least one polymer having at least one carboxylic acid group or salt thereof to form the pigment composition.

The pigment composition of Example 1 was prepared as follows. 70 g of BP700 was suspended in 300 mL of absolute methanol and placed in a 1 L, 1-neck round bottom flask. To this stirred mixture, at room temperature, was added 2.1 g of PEHA (3 parts per hundred (pph) based on the amount of pigment). Stirring was continued for 15 minutes, and then the solvent was removed in vacuo, at 50° C., on a rotary evaporator. The resulting powder was vacuum dried at 50° C. in a vacuum oven, overnight, resulting in a coated pigment powder.

A Brabender high shear mixer was pre-heated to 140° C., and to this was added 45 g of J683 under agitation, to form a polymer melt. 15 g of the coated pigment was then added into the melted polymer over approximately 5 minutes. The temperature of the mixture was adjusted to approximately 160° C. and mixed for 60 minutes. The mixer was then stopped, and the contents were cooled to ambient temperature.

Upon cooling, the resulting solid residue was dispersed in DI water containing NaOH (in an amount equivalent to 1.1 times the polymer acid number) using a rotor/stator mixing device. The dispersion was then purified by diafiltration to remove soluble impurities using 10 volumes of a 0.1 M NaOH solution followed by sufficient volumes of DI water until the conductivity of the permeate was less than or equal to 250 μS. Additional comminution (sonication) and/or centrifugation were performed to form a stable dispersion of the pigment composition of the present invention having a final particle size of less than 200 nm (10-15% solids). The dispersion was found to have 13895 ppm sodium (on a solids basis), measured using an ion selective electrode, indicating the presence of J683 remaining in the pigment composition. These results are also shown in Table 1 below.

The pigment compositions of Examples 2-17 were prepared using the procedure described for Example 1, with a different pigment type, different amount of polyamine (PEHA), different polymer to pigment ratio (ratio of the weight of polymer having at least one carboxylic acid group or salt thereof (J683) to the weight of the coated pigment), and/or different mixing conditions. The specifics for each example are shown in Table 1 above, along with the correspondingly measured sodium levels. Comparative pigment compositions (Comparative Examples 1-4) were also prepared using the procedure described for Example 1, with the specific components, conditions, and resulting sodium levels shown in Table 1 above. For each of these comparative pigment compositions, a Haake high shear mixer was used, and no polyamine (PEHA) was included. Thus, no coated pigment was formed before combining with the polymer melt.

TABLE 1

| | Pigment | PEHA | Polymer | Mixer | Time | Temp | Na⁺ |
|---|---|---|---|---|---|---|---|
| Ex. # | Type | (pph) | ratio | type | (h) | (° C.) | (ppm) |
| 1 | BP700 | 3 | 3 | Brabender | 1 | 160 | 13895 |
| 2 | BP700 | 2 | 5 | Brabender | 1 | 160 | 9229 |
| 3 | BP700 | 5 | 3 | Brabender | 1 | 160 | 22365 |
| 4 | BP700 | 5 | 3 | Brabender | 1 | 160 | 20499 |
| 5 | BP700 | 2 | 3 | Brabender | 1 | 180 | 18539 |
| 6 | BP700 | 5 | 5 | Brabender | 1 | 180 | 27534 |
| 7 | BP700 | 2 | 3 | Brabender | 4 | 180 | 28260 |
| 8 | BP700 | 2 | 5 | Brabender | 4 | 180 | 29682 |
| 9 | BP700 | 2 | 5 | Brabender | 4 | 160 | 27189 |
| 10 | BP700 | 5 | 5 | Brabender | 4 | 160 | 39305 |
| 11 | BP700 | 3 | 2 | Haake | 1 | 160 | 14777 |
| Comp | BP700 | 0 | 2 | Haake | 0.5 | 160 | 12975 |
| Ex 1 | | | | | | | |
| 12 | SS4 | 5 | 5 | Brabender | 1 | 160 | 17798 |
| 13 | SS4 | 2 | 3 | Brabender | 1 | 160 | 20872 |
| 14 | PR122 | 3 | 2 | Haake | 1 | 165 | 22928 |
| 15 | PR122 | 2 | 2 | Haake | 1 | 160 | 22336 |
| Comp | PR122 | 0 | 2 | Haake | 0.5 | 165 | 18054 |
| Ex 2 | | | | | | | |
| 16 | PB15:4 | 3 | 2 | Haake | 1 | 160 | 20736 |
| Comp | PB15:4 | 0 | 2 | Haake | 0.5 | 163 | 12485 |
| Ex 3 | | | | | | | |
| 17 | PY74 | 3 | 2 | Haake | 1 | 160 | 6438 |
| Comp | PY74 | 0 | 2 | Haake | 0.5 | 160 | 2019 |
| Ex 4 | | | | | | | |

All of the resulting dispersions comprising the pigment compositions of the present invention were stable with a particle size of less than 200 nm (generally approximately 150 nm). As the results in Table 1 show, these pigment compositions also had a high level of sodium, indicating the presence of a large amount of the polymer (J683) in the pigment composition, even after substantial diafiltration. Also, the higher the amount of polyamine and the higher the polymer to pigment ratio, the greater the sodium level. The effect of the amount of polyamine is particularly noticeable comparing Examples 11, 15, 16, and 17 to Comparative Examples 1, 2, 3, and 4 respectively, in which no PEHA was used. The results show that higher levels of sodium were observed for the pigment compositions of the present invention than for the comparative pigment compositions. Thus, the polyamine enables a higher level of polymer to be incorporated in the pigment composition. Therefore, these examples show that a dispersion of a pigment composition having good overall properties can be prepared by combining a pigment and a polyamine to form a coated pigment, and combining the coated pigment and a polymer having at least one carboxylic acid group or salt thereof as a melt.

### Examples 18-37

The following examples relate to an embodiment of the present invention in which a pigment composition is prepared by forming a melt of a polymer having at least one carboxylic acid group or salt thereof and adding a polyamine and a pigment, in any order, to the melt of the polymer to form the pigment composition. For these examples, the pigment is added prior to the polyamine.

### Examples 18-28

The pigment composition of Example 18 was prepared as follows. A Haake high shear mixer was pre-heated to 140° C., and to this was added 252 g J683 under agitation, to form a polymer melt. 126 g of BP700 was then added into the melted polymer over approximately 5 minutes. The temperature of the mixture was adjusted to 160° C., and the components were mixed for 15 minutes. After the initial mixing phase, 3.8 g PEHA was added into the mixture under agitation. The mixing was continued at 160° C. for 30 minutes. The mixer was then stopped, and the contents were cooled to ambient temperature.

Upon cooling, the resulting solid residue was dispersed in DI water containing NaOH (in an amount equivalent to 1.1 times the polymer acid number) using a rotor/stator mixing device. The dispersion was then purified by diafiltration to remove soluble impurities using 10 volumes of a 0.1 M NaOH solution followed by sufficient volumes of DI water until the conductivity of the permeate was less than or equal to 250 μS. Additional comminution (sonication) and/or centrifugation were performed to form a stable dispersion of the pigment composition of the present invention having a final particle size of less than 200 nm (10-15% solids). The dispersion was found to have 15036 ppm sodium (on a solids basis), measured using an ion selective electrode, indicating the presence of J683 remaining in the pigment composition. These results are also shown in Table 2 below.

The pigment compositions of Examples 19-28 were prepared using the procedure described for Example 18, with a different pigment type, different amount and type of polyamine, and/or different mixing conditions (time and/or temperature). The polymer to pigment ratio (ratio of the weight of polymer having at least one carboxylic acid group or salt thereof (J683) to the weight of the pigment) was the same. The specifics for each example are shown in Table 2 below (the amount of polyamine is in parts per hundred (pph) based on the amount of pigment), along with the correspondingly measured sodium levels.

TABLE 2

| | Pigment | Polyamine | Polyamine | Polymer | Time | Temp | Na⁺ |
|---|---|---|---|---|---|---|---|
| Ex. # | Type | type | (pph) | ratio | (h) | (° C.) | (ppm) |
| 18 | BP700 | PEHA | 3 | 2 | 0.5 | 167 | 15036 |
| 19 | BP700 | PEHA | 23 | 2 | 0.25 | 172 | 13090 |
| 20 | BP700 | HMDA | 3 | 2 | 1 | 160 | 22900 |
| 21 | PB15:4 | PEHA | 23 | 2 | 0.5 | 168 | 17600 |
| 22 | PB15:4 | PEHA | 3 | 2 | 0.5 | 162 | 16040 |
| 23 | PR122L | PEHA | 23 | 2 | 0.5 | 168 | 20622 |
| 24 | PR122L | PEHA | 3 | 2 | 0.5 | 160 | 15656 |
| 25 | PR122S | PEHA | 23 | 2 | 0.75 | 170 | 25954 |
| 26 | PR122S | PEHA | 3 | 2 | 1 | 165 | 28087 |
| 27 | PY74 | PEHA | 23 | 2 | 0.5 | 169 | 4961 |
| 28 | PY74 | PEHA | 3 | 2 | 0.5 | 167 | 6455 |

As the results in Table 2 show, pigment compositions of the present invention had a very high level of sodium, indicating the presence of a large amount of the polymer (J683) in the pigment composition, even after substantial diafiltration. Also, all of the resulting dispersions comprising these pigment compositions were stable with a particle size of less than 200 nm (generally less than 150 nm). Therefore, these examples show that a dispersion of a pigment composition having good overall properties can be prepared by combining a pigment and a polyamine into a polymer melt of a polymer having at least one carboxylic acid group or salt thereof.

### Examples 29-37

The pigment compositions of these examples were prepared using the procedure described for Example 18, with a different pigment type, different amount of polyamine (PEHA), and/or different mixing conditions (a 1 hour mixing time was used after combining the pigment and the polymer melt). The polymer to pigment ratio (ratio of the weight of polymer having at least one carboxylic acid group or salt thereof (J683) to the weight of the pigment) was the same. The pigment in each of these examples was a modified pigment comprising a pigment having attached at least one organic group, wherein the organic group is a benzyl amine group. The specifics for each example are shown in Table 3 below, including the type of pigment modified (the amount of PEHA is in parts per hundred (pph) based on the amount of pigment), along with the correspondingly measured sodium levels.

The modified pigment is prepared using the following general procedure. The pigment was added to a Ross mixer, which was initially heated to 30° C., and to this was added 4-aminobenzyl amine (4-ABA, 0.4 mmoles/g pigment on a dry pigment weight basis), methane sulfonic acid (molar ratio of acid to 4-ABA was 1) as a 23% by weight solution in water, and sufficient water to achieve a 25% solids reaction mixture after addition of nitrite, described in the next step. After mixing for 15 minutes, a 16.7% by weight aqueous solution of sodium nitrite (molar ratio of nitrite to 4-ABA was 1) was then added slowly over 30 minutes. The reaction mixture was then mixed at 30° C. for 30 minutes. This was then slowly heated to 50° C., and the mixture was mixed at this temperature for an additional 30 minutes (total reaction time after addition of sodium nitrite solution was 2 hours). After this time, the mixture was cooled to room temperature, and to this was added a 10% aqueous solution of sodium hydroxide (molar ratio of base to acid of 1). The resulting dispersion of modified pigment was removed from the mixer and used as is for preparing the pigment composition.

TABLE 3

| | Pigment | PEHA | Polymer | Time | Temp | Na⁺ |
|---|---|---|---|---|---|---|
| Ex. # | Type | (pph) | ratio | (h) | (° C.) | (ppm) |
| 29 | BP700 | 23 | 2 | 0.5 | 165 | 16262 |
| 30 | BP700 | 12 | 2 | 0.25 | 175 | 14035 |
| 31 | BP700 | 3 | 2 | 0.5 | 172 | 22031 |
| 32 | PB15:4 | 23 | 2 | 0.3 | 170 | 18899 |
| 33 | PB15:4 | 3 | 2 | 0.5 | 170 | 29439 |
| 34 | PR122 | 23 | 2 | 0.3 | 170 | 17974 |
| 35 | PR 122 | 3 | 2 | 0.5 | 170 | 25828 |
| 36 | PY74 | 23 | 2 | 0.5 | 163 | 8608 |
| 37 | PY74 | 3 | 2 | 0.5 | 170 | 26039 |

As the results in Table 3 show, pigment compositions of the present invention had a very high level of sodium, indicating the presence of a large amount of the polymer (J683) in the pigment composition, even after substantial diafiltration. Also, at extremely high levels of polyamine, it was found that the resulting pigment compositions had somewhat lower levels of sodium, perhaps due to reaction of the polyamine with the carboxylic acid groups of the polymer. All of the resulting dispersions comprising the pigment compositions of the present invention were stable with a particle size of less than 200 nm (generally less than 150 nm). Therefore, these examples show that a dispersion of a pigment composition having good overall properties can be prepared by combining a modified pigment and a polyamine into a polymer melt of a polymer having at least one carboxylic acid group or salt thereof.

### Example 38

The following example relates to an embodiment of the present invention in which a pigment composition is prepared by forming a melt of a polymer having at least one carboxylic acid group or salt thereof and adding a polyamine and a pigment, in any order, to the melt of the polymer to form the pigment composition. For this example, the polyamine was added prior to the pigment.

A Haake high shear mixer was pre-heated to 140° C., and to this was added 252 g J683 under agitation, to form a polymer melt. 29 g of PEHA was then added into the melted polymer over approximately 25 minutes. The temperature of the mixture was adjusted to 160° C., and the components were mixed for 30 minutes. After the initial mixing phase, 126 g of BP700 was added into the mixture under agitation. The mixing was continued at 160° C. for an additional 10 minutes. The mixer was then stopped and the contents were cooled to ambient temperature.

Upon cooling, the resulting solid residue was dispersed in DI water containing NaOH (in an amount equivalent to 1.1 times the polymer acid number) using a rotor/stator mixing device. The dispersion was then purified by diafiltration to remove soluble impurities using 10 volumes of a 0.1 M NaOH solution followed sufficient volumes of DI water until the conductivity of the permeate was less than or equal to 250 μS. Additional comminution (sonication) and/or centrifugation were performed to form a stable dispersion of the pigment composition of the present invention having a final particle size of less than 200 nm (10-15% solids). The dispersion was found to have 9468 ppm sodium (on a solids basis), measured using an ion selective electrode, indicating the presence of J683 remaining in the pigment composition, even after substantial diafiltration. Therefore, this example shows that a dispersion of a pigment composition having good overall properties can be prepared by combining a modified pigment and a polyamine into a polymer melt of a polymer having at least one carboxylic acid group or salt thereof.

### Examples 39-45 and Comparative Examples 5-10

The following examples relate to an embodiment of the present invention in which a pigment composition is prepared by forming a melt of a polymer comprising a first polymer having at least one carboxylic acid group or salt thereof and second polymer and adding a polyamine and a pigment, in any order, to the melt of the polymer mixture to form the pigment composition. The second polymer is either a polymer having at least one carboxylic acid group or salt thereof (that is different from the first polymer, having a lower acid number and a lower solubility in water) or is a polymer comprising at least one reactive with the polyamine, such as an anhydride group, and has either a very low solubility in water or is water insoluble. For each of these examples, the pigment is added prior to the polyamine.

The pigment compositions of Examples 39-45 were prepared using the procedure described for Example 18, with the exception that two different polymers were used. The polymer melt was formed by first forming a melt of the first polymer, as described in Example 18 using a Haake mixer and then adding the second polymer until a consistent melt results. For each example, the pigment was BP700, the polyamine was PEHA, and the first polymer was J683. Different types and levels of second polymer were used, with different amounts of polyamine and/or different mixing conditions (time and/or temperature). The polymer to pigment ratio (ratio of the weight of total polymer to the weight of the pigment) was 2. Comparative pigment compositions (Comparative Examples 5-10) were also prepared using the procedure described for Example 18, without any polyamine. For Examples 39-41 and Comparative Examples 5-6, the second polymer was Joncryl 611 (J611, a polymer having at least one carboxylic acid group or salt thereof, available from BASF) while for Examples 42-45 and Comparative Example 7-10, the second polymer was either SMA™ EF40 or SMA™ EF80 (EF40 or EF80, styrene maleic anhydride copolymers available from Sartomer Company, Inc.). The specifics for each example are shown in Table 4 below (the amounts of PEHA and second polymer are in parts per hundred (pph) based on the amount of pigment), along with the correspondingly measured sodium levels.

TABLE 4

| | | Second | Second | | | |
|---|---|---|---|---|---|---|
| | PEHA | Polymer | Polymer | Time | Temp | Na⁺ |
| Ex. # | (pph) | Type | Amt (pph) | (h) | (° C.) | (ppm) |
| 39 | 5 | J611 | 10 | 1 | 172 | 24700 |
| 40 | 2.5 | J611 | 15 | 1 | 165 | 16700 |
| 41 | 5 | J611 | 20 | 1 | 173 | 30747 |
| Comp Ex 5 | 0 | J611 | 10 | 1.25 | 165 | 19100 |
| Comp Ex 6 | 0 | J611 | 20 | 1.25 | 169 | 17290 |
| 42 | 5 | EF40 | 10 | 0.5 | 170 | 24478 |
| 43 | 5 | EF40 | 20 | 0.03 | 165 | 22550 |
| Comp Ex 7 | 0 | EF40 | 10 | 1.25 | 165 | 23800 |
| Comp Ex 8 | 0 | EF40 | 20 | 1.25 | 165 | 29460 |
| 44 | 5 | EF80 | 10 | 1 | 171 | 25438 |
| 45 | 5 | EF80 | 20 | 0.03 | 174 | 13090 |
| Comp Ex 9 | 0 | EF80 | 10 | 1.25 | 167 | 15224 |
| Comp Ex 10 | 0 | EF80 | 20 | 1.25 | 162 | 24170 |

As the results in Table 4 show, pigment compositions of the present invention had a very high level of sodium, indicating the presence of a large amount of the polymer in the pigment composition. Also, all of the resulting dispersions comprising the pigment compositions of the present invention were stable with a particle size of less than 200 nm (generally less than 150 nm). Thus, a polymer that has either a very low water solubility or is water insoluble may be used, in combination with a polymer having at least one carboxylic acid group or salt thereof, without loss of dispersion stability. Therefore, these examples show that a dispersion of a pigment composition having good overall properties can be prepared by combining a pigment and a polyamine into a polymer melt of a mixture of polymers, one being a polymer having at least one carboxylic acid group or salt thereof.

### Examples 46-51

The following examples relate to an embodiment of the present invention in which a pigment composition is prepared by combining a polyamine and a pigment to form a coated pigment and combining the coated pigment and at least one polymer having at least one carboxylic acid group or salt thereof to form the pigment composition.

For each of these examples, the following general procedure was followed. BP700 was added to a 2 liter planetary mixer from Ross (Model PD-1/2). To this was added PEHA (as a 25% solution in water), and the mixture was stirred at 15-60° C. for 15-30 minutes, forming a coated pigment as a wet powder. J683 was then added as either as dry solid or as a 20% solution in 28% ammonium hydroxide. The temperature was then raised to approximately 170° C. and the combination was mixed at this temperature for approximately 5 hours.

Upon cooling, the resulting solid residue was dispersed in DI water containing NaOH (in an amount equivalent to 1.7 times the polymer acid number), and the dispersion was then purified by diafiltration to remove soluble impurities using 10 volumes of a 0.1 M NaOH solution followed sufficient volumes of DI water until the conductivity of the permeate was less than or equal to 250 μS to form a stable dispersion of the pigment composition of the present invention having a final particle size of less than 200 nm (10-15% solids).

The specifics for each example are shown in Table 5 below (the amount of PEHA is in parts per hundred based on the amount of pigment, and the polymer ratio is the ratio of the weight of the polymer to the weight of the pigment), along with both thermogravimetric analysis (TGA) results of the pigment composition and the resulting amount of sodium (on a solids basis), measured using an ion selective electrode. Both can be used as an indication of the presence of J683 remaining in the pigment composition.

TABLE 5

| | | Polymer | | | | | |
|---|---|---|---|---|---|---|---|
| | PEHA | Solution | Polymer | Time | Temp | TGA | Na⁺ |
| Ex. # | (pph) | Conc (wt %) | ratio | (min) | (° C.) | (%) | (ppm) |
| 46 | 3.5 | 60 | 1 | 300 | 158 | 35.4 | 19200 |
| 47 | 5 | 30 | 0.5 | 337 | 171 | 35.1 | 12403 |
| 48 | 3.5 | 60 | 1 | 298 | 151 | 31.4 | 21088 |
| 49 | 2 | 100 (solid) | 0.5 | 331 | 158 | 14.0 | 8180 |
| 50 | 5 | 100 (solid) | 1.5 | 315 | 171 | 22.9 | 12576 |
| 51 | 2 | 100 (solid) | 0.5 | 305 | 172 | 19.1 | 11573 |

As the results in Table 5 show, pigment compositions of the present invention had a high level of sodium, indicating the presence of a large amount of the polymer (J683) in the pigment composition, even after substantial diafiltration. Also, all of the resulting dispersions comprising these pigment compositions were stable with a particle size of less than 200 nm (generally less than 150 nm). Therefore, these examples show that a dispersion of a pigment composition having good overall properties can be prepared by combining a pigment and a polyamine to form a coated pigment, and combining the coated and a polymer having at least one carboxylic acid group or salt thereof as either a solid or as a solution.

### Examples 52-54 and Comparative Examples 11-12

The following examples relate to embodiments of the inkjet ink composition of the present invention

Inkjet ink composition were prepared using the following general formulation (all % are % by weight): 7% trimethylolpropane, 1% Surfynol 465, 5% diethyleneglycol, 7% glycerin, 4% pigment, with the balance DI water. Images were printed using a Canon iP4000 thermal inkjet printer and were evaluated for both optical density (OD) and highlighter smear resistance. Average optical density was determined on images printed onto 7 different types of paper (Hammermill Inkjet, Hammermill Copy Plus, HP Advanced, HP Bright White, HP Multipurpose, HP Plain Paper, and Xerox 4200). OD of the printed image was determined using ImageXpert™). Five measurements of OD were performed on the printed image on each type of paper and averaged across all paper types. Smear values were determined using a Sharpie Accent yellow highlighter on images printed on HP Multipurpose paper. For this measurement, two passes were made on an unprinted section of paper, to form a blank, and then two passes were made across the printed image. The highlighter pen was cleaned between tests. Smear values were determining by measuring the amount of OD transfer (comparing the OD of the smeared section to the OD of the blank).

The inkjet ink compositions of Examples 52, 53, and 54 comprised the pigment compositions of Examples 2, 5, and 9 respectively. The inkjet ink composition of Comparative Example 11 comprised a polymer modified pigment prepared by reacting BP700, 4-aminophenyl-2-sulfatoethylsulfone (APSES, 0.5 mmoles/g pigment), and sodium nitrite (1 mole/mole APSES) in DI water (1.5 g/g pigment) to form a carbon black pigment having attached phenyl-2-(sulfatoethylsulfone) groups, reacting this modified pigment with PEHA (1.25 mmol/g pigment) in DI water at a pH>12 to form a modified carbon black having attached amine groups (dispersed at a pH of 3), and finally mixing this dispersion with Joncryl 683 (1 g/g pigment) and heating to 175° C. for 18 hours to form a polymer modified carbon black. Thus, this comparative inkjet ink composition comprised an attached polyamine and polymer having at least one carboxylic acid group or salt thereof. Finally, the inkjet ink composition of Comparative Example 12 comprised BP700 dispersed conventionally with J683 (25% by weight based on the weight of the pigment) The sodium numbers of the pigment compositions used in Comparative Examples 11 and 12 are similar to those of the pigment compositions of Examples 2, 5, and 9.

The inkjet ink compositions of Examples 55-57 comprised the pigment compositions of Examples 39-41 respectively, which were prepared using two different types of polymers having at least one carboxylic acid group or salt thereof as a melt, and the inkjet ink compositions of Comparative Examples 13-14 comprised the pigment compositions of Comparative Examples 5-6 respectively. Also, the inkjet ink compositions of Examples 58-61 comprised the pigment compositions of Examples 42-45 respectively, which were prepared using a polymer having at least one carboxylic acid group or salt thereof and a polymer having at least one anhydride group as a melt, and the inkjet ink compositions of Comparative Examples 15-18 comprised the pigment compositions of Comparative Examples 7-10 respectively.

Print performance properties are shown in Table 6 below. As the results show, the inkjet ink composition of Examples 52-24, comprising a pigment composition of the present invention, produced printed images having comparable or higher average optical density compared to images produced using the comparative inkjet ink compositions, along with surprisingly improved (lower) highlighter OD transfer. Thus, these inkjet ink compositions of the present invention were found to produce images having an improved balance of both OD and highlighter smear resistance over the comparative inkjet ink compositions. For the inkjet ink compositions of Examples 55-61, comprising a pigment composition of the present invention, these produced images having comparable OD and smear values to the inkjet ink compositions of Comparative Examples 13-14, and the print performance was related to the amount of total polymer used. As the amount of the second polymer increased, OD generally dropped and smear values generally increased, indicating a preferred range of second polymer to produce improved performance.

TABLE 6

| | | | Hilighter OD |
|---|---|---|---|
| Ex. # | Pigment Type | Average OD | transfer |
| 52 | Pigment of Ex 2 | 1.30 | 0.30 |
| 53 | Pigment of Ex 5 | 1.23 | 0.29 |
| 54 | Pigment of Ex 9 | 1.19 | 0.24 |
| Comp Ex 11 | Polymer modified | 1.22 | 0.36 |
| Comp Ex 12 | Conventional dispersion | 1.19 | 0.36 |
| 55 | Pigment of Ex 39 | 1.42 | 0.29 |
| 56 | Pigment of Ex 40 | 1.34 | 0.34 |
| 57 | Pigment of Ex 41 | 0.85 | 0.21 |
| Comp Ex 13 | Pigment of Comp Ex 5 | 1.41 | 0.30 |
| Comp Ex 14 | Pigment of Comp Ex 6 | 1.36 | 0.32 |
| 58 | Pigment of Ex 42 | 1.35 | 0.24 |
| 59 | Pigment of Ex 43 | 1.42 | 0.36 |
| Comp Ex 15 | Pigment of Comp Ex 7 | 1.40 | 0.33 |
| Comp Ex 16 | Pigment of Comp Ex 8 | 1.33 | 0.27 |
| 60 | Pigment of Ex 44 | 1.25 | 0.30 |
| 61 | Pigment of Ex 45 | 1.44 | 0.34 |
| Comp Ex 17 | Pigment of Comp Ex 9 | 1.23 | 0.35 |
| Comp Ex 18 | Pigment of Comp Ex 10 | 1.29 | 0.32 |

The foregoing description of preferred embodiments of the present invention has been presented for the purposes of illustration and description. It is not intended to be exhaustive or to limit the invention to the precise form disclosed. Modifications and variations are possible in light of the above teachings, or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. A method of preparing a pigment composition comprising the steps of:
i) combining a polyamine and a pigment to form a coated pigment; and
ii) combining the coated pigment and at least one polymer having at least one carboxylic acid group or salt thereof to form the pigment composition, wherein the polymer is in the form of a polymer melt.

2. The method of claim 1, wherein the polyamine is in the form of a solution in a first solvent, and wherein the method further comprises the step of removing the first solvent to form the coated pigment, wherein the first solvent is a non-aqueous solvent.

3. The method of claim 1, wherein the pigment is in the form of a dispersion of the pigment in a second solvent, and wherein the method further comprises the step of removing the second solvent to form the coated pigment, wherein the second solvent is an aqueous solvent.

4. The method of claim 1, wherein the pigment is a modified carbon product comprising a carbon product having attached at least one organic group, and wherein the organic group comprises at least one alkyl amine group.

5. The method of claim 1, wherein the polymer melt comprises a first polymer having at least one carboxylic acid group or salt thereof and a second polymer having at least one carboxylic acid group or salt thereof, wherein the first polymer has an acid number of between about 20 and about 100 and wherein the second polymer has an acid number of between about 110 and about 400.

6. The method of claim 1, wherein the polymer melt comprises a first polymer having at least one carboxylic acid group or salt thereof and a second polymer having at least one non-carboxylic acid group or salt thereof capable of reacting with an amino group.

7. The method of claim 1, wherein the coated pigment and the polymer melt are combined under high intensity mixing conditions.

8. The method of claim 1, wherein the coated pigment comprises the polyamine adsorbed onto the pigment.

9. The method of claim 1, wherein the coated pigment comprises a reaction product of the polyamine and the pigment

10. The method of claim 1, wherein the pigment composition comprises a reaction product of the coated pigment and the polymer.

11. A method of preparing a pigment composition comprising the steps of:
i) combining a polyamine and a pigment to form a coated pigment;
ii) combining the coated pigment and at least one polymer having at least one carboxylic acid group or salt thereof to form a mixture, and
iii) heating the mixture to a temperature sufficient to melt the polymer to form the pigment composition.

12. A method of preparing a pigment composition comprising the steps of:
i) forming a melt of a polymer having at least one carboxylic acid group or salt thereof; and
ii) adding a polyamine and a pigment, in any order, to the melt of the polymer to form the polymer composition.

13. A method of preparing a pigment composition comprising the steps of:
i) combining a polymer having at least one carboxylic acid group or salt thereof, a polyamine, and a pigment, in any order, to form a mixture; and
ii) heating the mixture to a temperature sufficient to melt the polymer to form the polymer composition.

14. A pigment composition comprising a combination product of a coated pigment and at least one polymer having at least one carboxylic acid group or salt thereof, wherein the coated pigment comprises a combination product of a polyamine and a pigment.

15. The pigment composition of claim 14, wherein the combination product of the coated pigment and the polymer comprises a reaction product of the coated pigment and the polymer.

16. The pigment composition of claim 14, wherein the combination product of the polyamine and the pigment comprises the polyamine adsorbed onto the pigment.

17. The pigment composition of claim 14, wherein the combination product of the polyamine and the pigment comprises a reaction product of the polyamine and the pigment.

18. The pigment composition of claim 14, wherein the pigment composition comprises a pigment having adsorbed or attached at least one reacted polymer, wherein the reacted polymer has a weight average molecular weight that is at least 10 times greater than that of the polymer.

19. The pigment composition of claim 14, wherein the pigment composition comprises a pigment having adsorbed or attached at least one reacted polymer, wherein the reacted polymer is present in an amount of between about 20% and about 50% by weight based on the total weight of the pigment composition.

20. An inkjet ink composition comprising a) a liquid vehicle and b) a pigment composition comprising a combination product of a coated pigment and at least one polymer having at least one carboxylic acid group or salt thereof, wherein the coated pigment comprises a combination product of a polyamine and a pigment.

21. The inkjet ink composition of claim 20, wherein the combination product of the coated pigment and the polymer comprises a reaction product of the coated pigment and the polymer.

22. The inkjet ink composition of claim 20, wherein the combination product of the polyamine and the pigment comprises the polyamine adsorbed onto the pigment.

23. The inkjet ink composition of claim 20, wherein the combination product of the polyamine and the pigment comprises a reaction product of the polyamine and the pigment.

24. The inkjet ink composition of claim 20, wherein the pigment composition comprises a pigment having adsorbed or attached at least one reacted polymer, wherein the reacted polymer has a weight average molecular weight that is at least 10 times greater than that of the polymer.

25. The inkjet ink composition of claim 20, wherein the pigment composition comprises a pigment having adsorbed or attached at least one reacted polymer, wherein the reacted polymer is present in an amount of between about 20% and about 50% by weight based on the total weight of the pigment composition.
